(19) United States
(12) Patent Application Publication
(10) Pub. No.: US 2026/0066601 A1
(43) Pub. Date: Mar. 5, 2026

(54) TERMINAL CRIMPING UNIT AND TERMINAL CRIMPING METHOD

(71) Applicant: Yazaki Corporation, Tokyo (JP)

(72) Inventors: Shingo NAKAJIMA, Makinohara-shi (JP); Yukitaka SONOHARA, Makinohara-shi (JP)

(73) Assignee: Yazaki Corporation, Tokyo (JP)

(21) Appl. No.: 19/385,382

(22) Filed: Nov. 11, 2025

Related U.S. Application Data
(63) Continuation of application No. PCT/JP2024/018019, filed on May 15, 2024.

(30) Foreign Application Priority Data
Jun. 15, 2023 (JP) 2023-098341

(51) Int. Cl. H01R 43/052; H01R 43/05

(52) U.S. Cl. CPC H01R 43/052; H01R 43/05

(57) ABSTRACT

Connector terminals are crimped to harness-use electric wires while various burdens on the worker are reduced. A terminal crimping unit includes a measuring section, a conveying section, a stripping section, a crimping section, a crimping confirmation section performing a crimping confirmation process based on a post-crimping image obtained by photographing electric wire end portions to which the connector terminals have been crimped, and a selective discarding section performing a selective discarding process of handing over to a subsequent step the harness-use electric wires that satisfy the crimping criteria and discarding the harness-use electric wires that do not satisfy the crimping criteria.

### TECHNICAL FIELD

This application is a continuation application of PCT International Application No. PCT/JP2024/018019, filed on May 15, 2024, whose priority is claimed on Japanese Patent Application No. 2023-098341, filed on June 15, 2023. All contents of both the PCT International Patent Application and the Japanese Patent Application are incorporated herein by reference.

The present invention relates to a terminal crimping unit and a terminal crimping method for crimping connector terminals to a harness-use electric wire.

### BACKGROUND

Conventionally, in the manufacture of wire harnesses having connectors at their ends, a terminal crimping unit that crimps connector terminals to a harness-use electric wire has been used (see, for example, Patent Document 1). In the terminal crimping unit described in Patent Document 1, an operator sets the harness-use electric wire that is cut out in a previous step to crimp the terminals.

### Related Art

### Patent Document

Patent Document 1: JPH09306257A

### SUMMARY OF THE INVENTION

### Problem to be Solved by the Invention

Here, in the above-mentioned terminal crimping unit, the work of cutting out a harness-use electric wire, which has not yet been crimped, and setting the harness-use electric wire into the terminal crimping unit tends to be a burden for the worker, and the burden increases as the number of electric wires increases.

Therefore, the present invention has been made in view of the above problems, and has an object to provide a terminal crimping unit and a terminal crimping method capable of crimping connector terminals to a harness-use electric wire while reducing various burdens on the worker.

### Solution to Problem

In order to solve the above problems, a terminal crimping unit includes a measuring section configured to cut out in sequence a plurality of harness-use electric wires by repeating a measuring process including pulling out and cutting a required length of an electric wire, a conveying section configured to receive in sequence the harness-use electric wires from the measuring section, grab and convey at least one of electric wire end portions along a predetermined conveying route, a stripping section configured to perform, on the harness-use electric wires conveyed along the conveying route, a stripping process for removing tip coatings of the electric wire end portions to expose core wires, a crimping section located downstream of the stripping section on the conveying route, and configured to perform, on the harness-use electric wires conveyed through the stripping section, a crimping process for crimping connector terminals to the electric wire end portions of which core wires are exposed, a crimping confirmation section located downstream of the crimping section on the conveying route, and configured to perform, on the harness-use electric wires conveyed through the crimping section, a crimping confirmation process of photographing the electric wire end portions to which the connector terminals have been crimped, and determining whether predetermined crimping criteria are satisfied based on a photographed post-crimping image, and a selective discarding section located downstream of the crimping confirmation section on the conveying route, and configured to perform, on the harness-use electric wires conveyed through the crimping confirmation section, a selective discarding process of handing over the harness-use electric wires that satisfy the crimping criteria to a subsequent step and discarding the harness-use electric wires that do not satisfy the crimping criteria.

Furthermore, in order to solve the above problems, a terminal crimping method includes a measuring step of cutting out in sequence a plurality of harness-use electric wires by repeating a measuring process including pulling out and cutting a required length of an electric wire, a conveying step of handing over the harness-use electric wires to a conveying section that grabs and conveys at least one of electric wire end portions along a predetermined conveying route, and causing the conveying section to convey the harness-use electric wires, a stripping step of removing tip coatings of the electric wire end portions of the harness-use electric wires conveyed along the conveying route to expose core wires, a crimping step of crimping connector terminals to the electric wire end portions, of which core wires are exposed, of the harness-use electric wires conveyed through the stripping step, a crimping confirmation step of photographing the electric wire end portions, to which the connector terminals have been crimped, of the harness-use electric wires conveyed through the crimping step, and determining whether predetermined crimping criteria are satisfied based on a photographed post-crimping image, and a selective discarding step of handing over to a subsequent step the harness-use electric wires that satisfy the crimping criteria and discarding the harness-use electric wires of the harness-use electric wires conveyed through the crimping confirmation step that do not satisfy the crimping criteria.

### Advantageous effects

According to the terminal crimping unit and the terminal crimping method described above, connector terminals can be crimped to a harness-use electric wire while reducing various burdens on the worker.

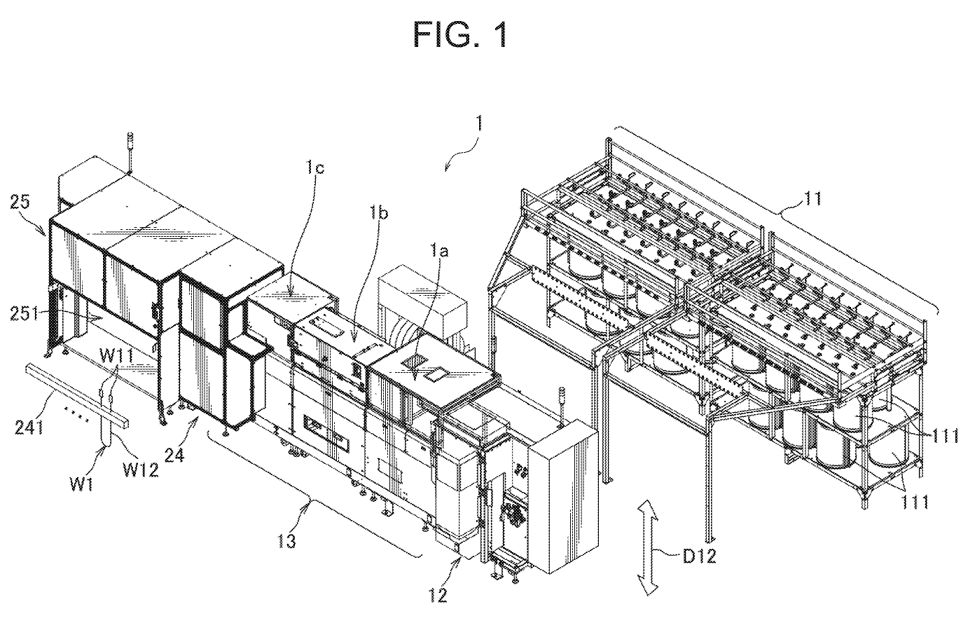

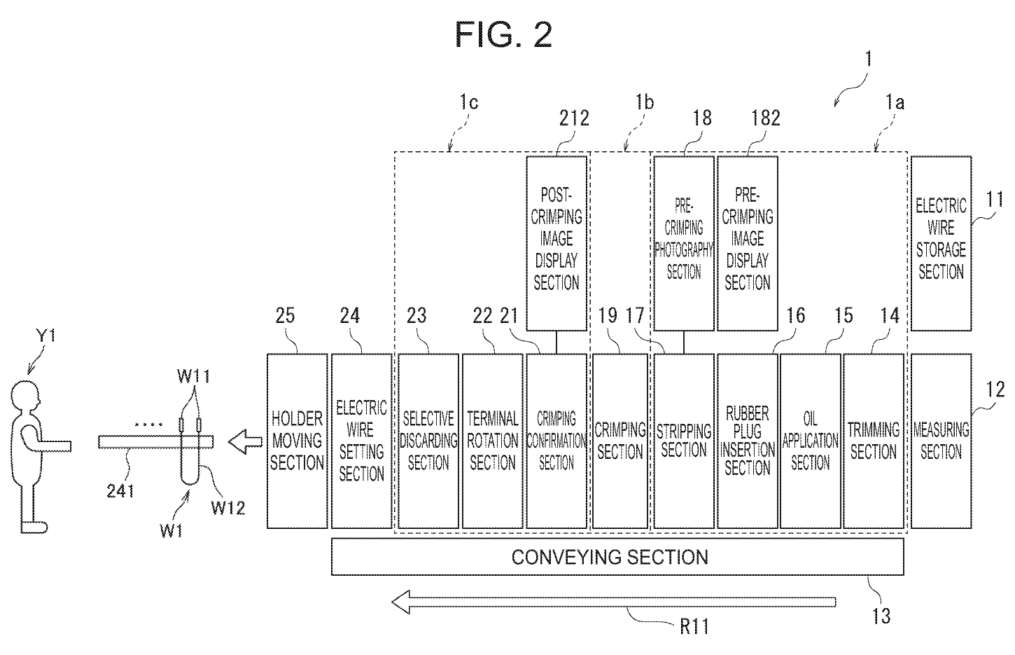

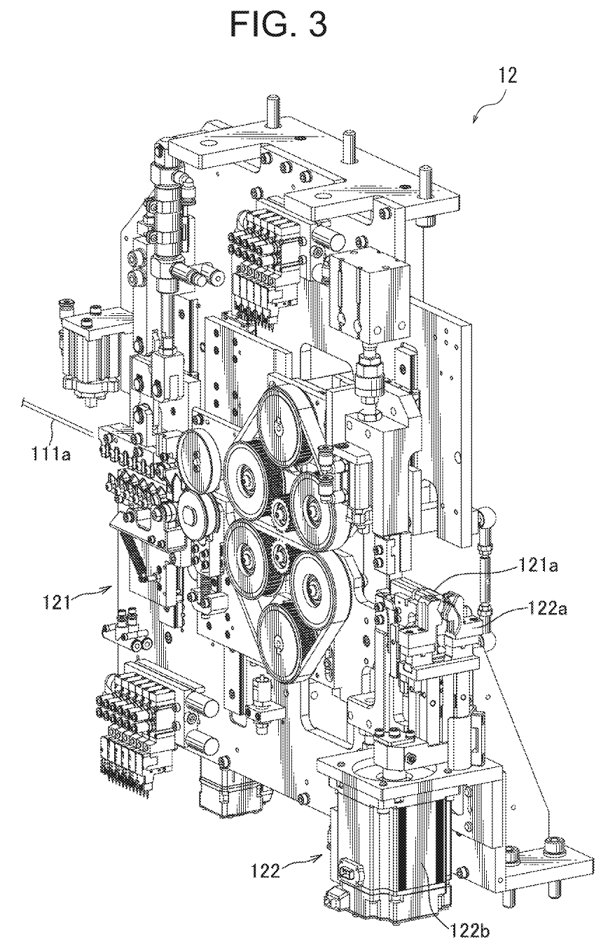

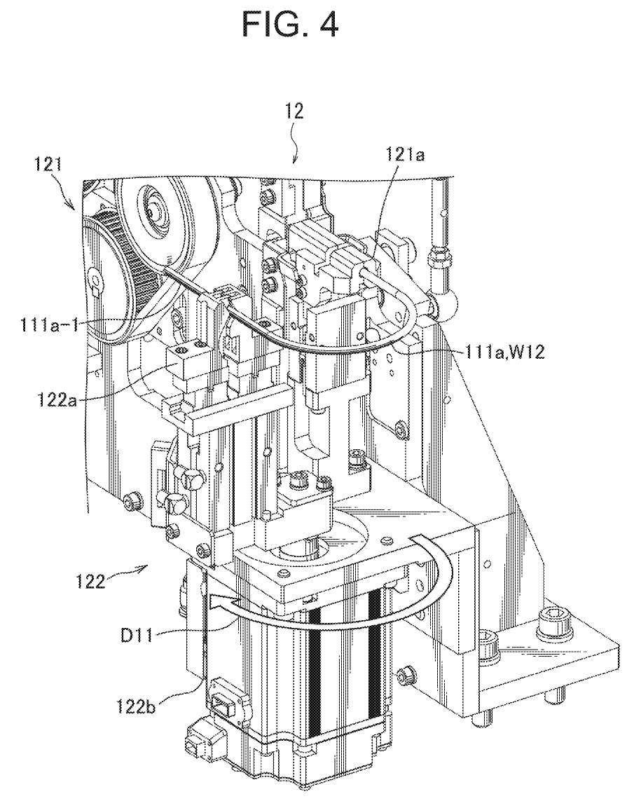

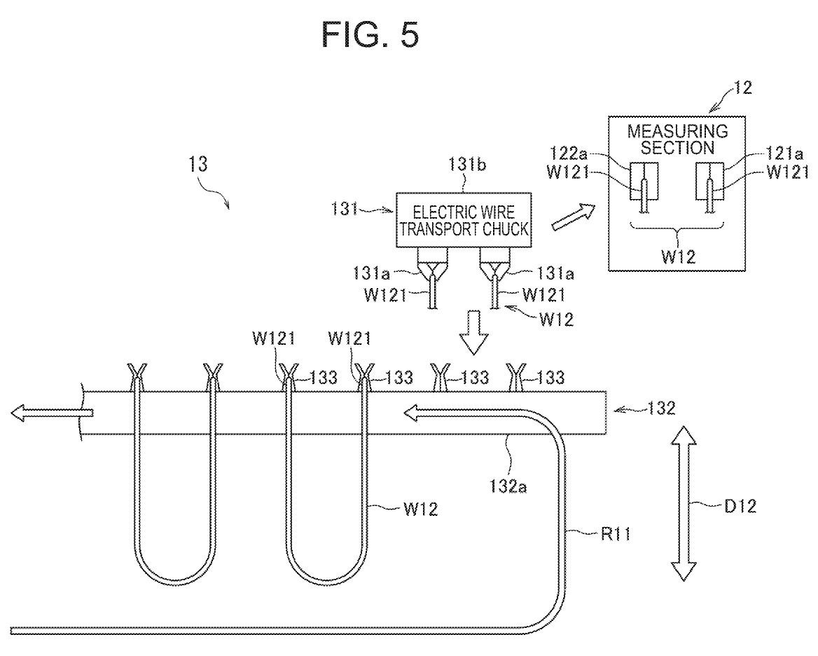

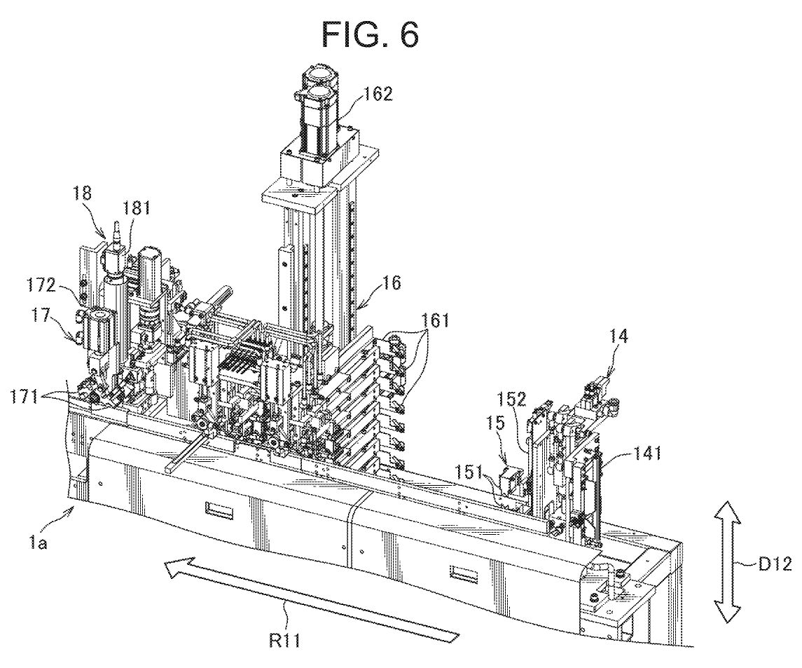

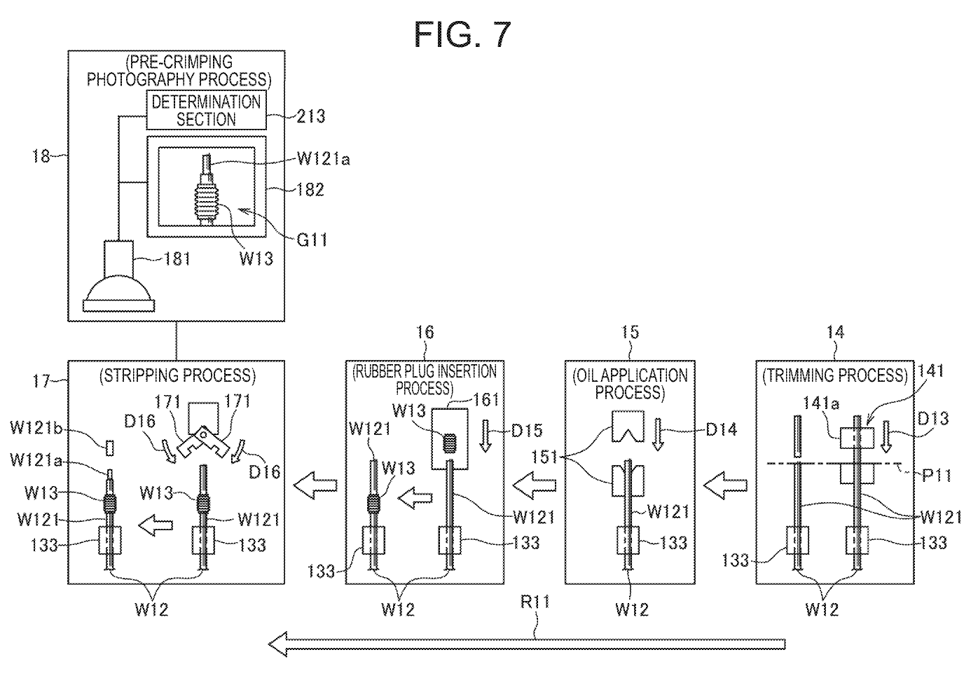

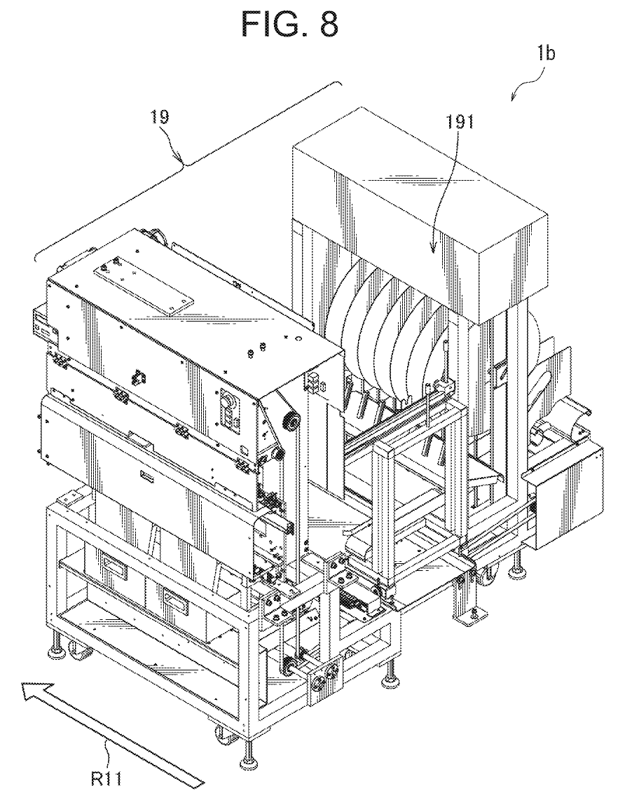

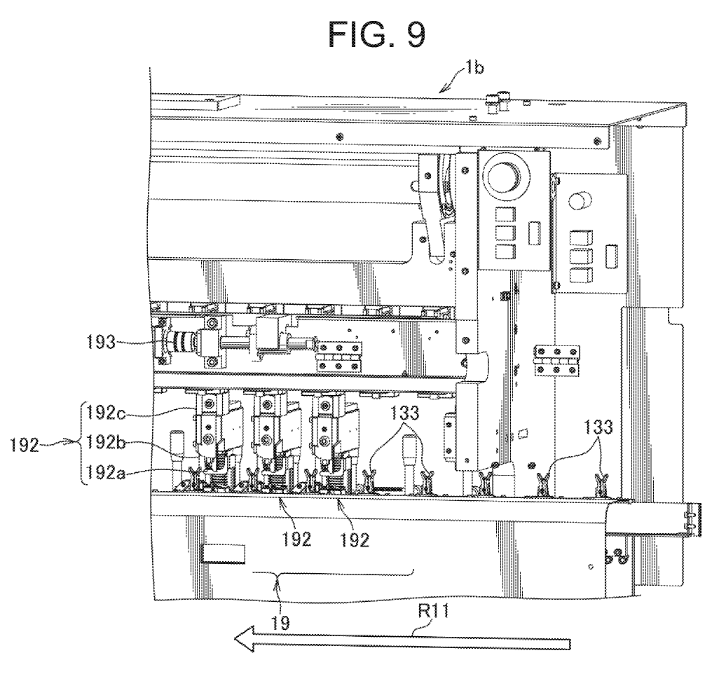

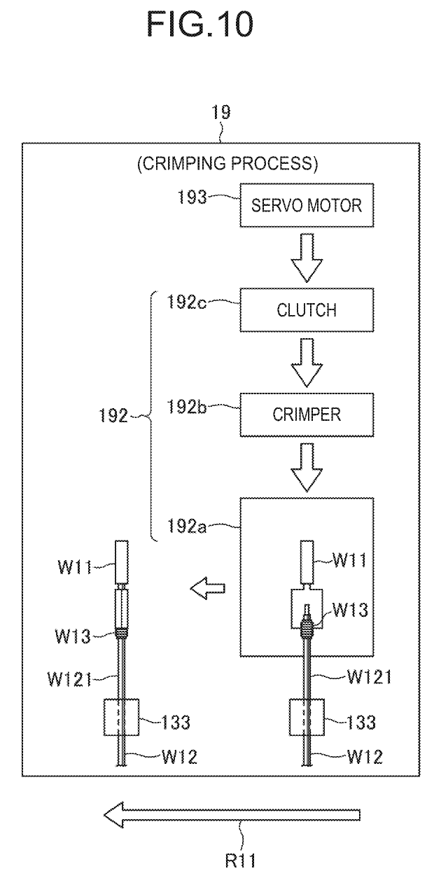

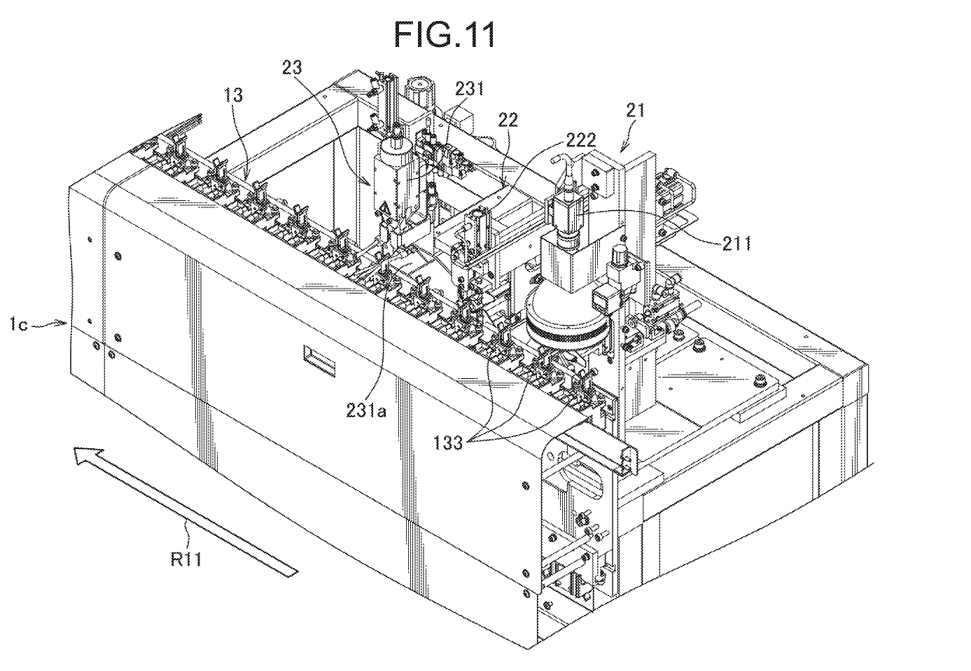

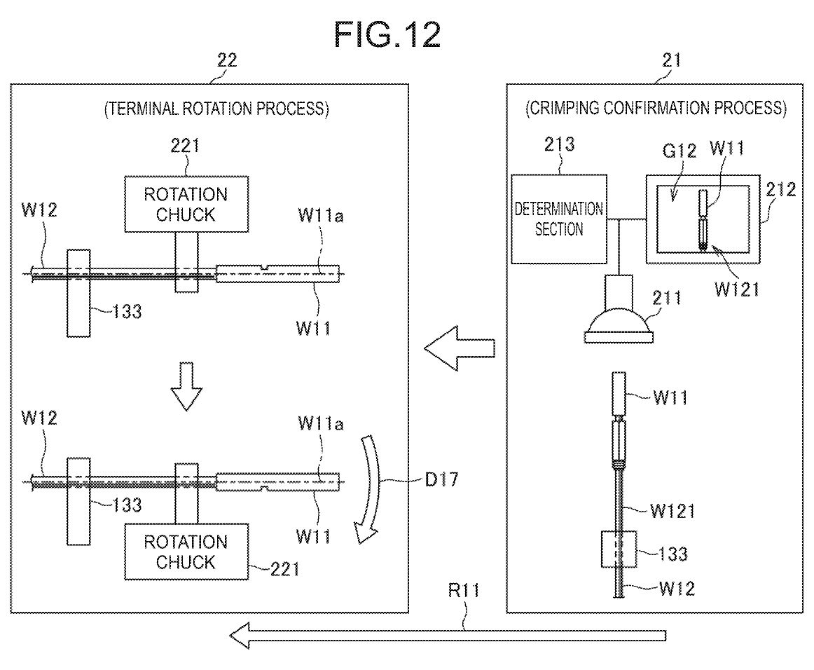

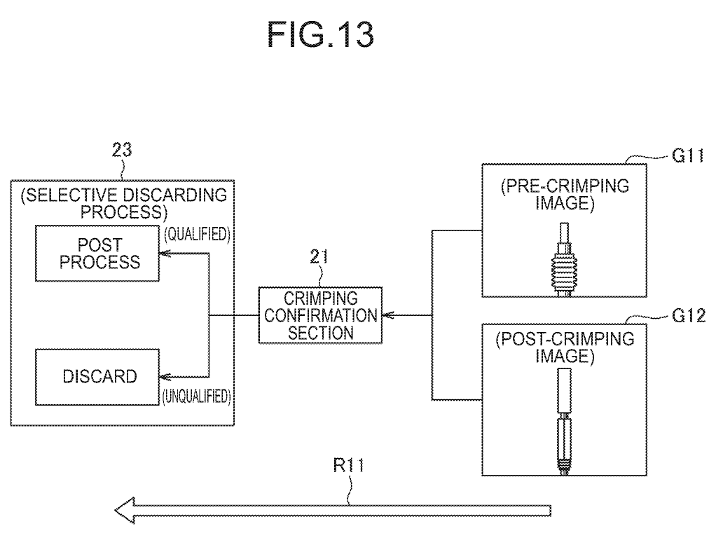

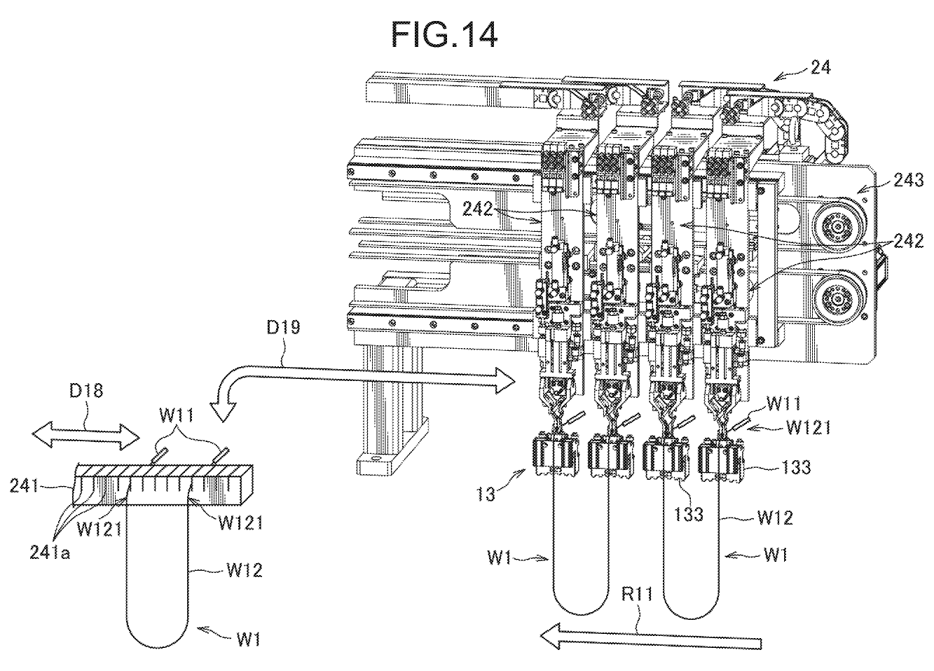

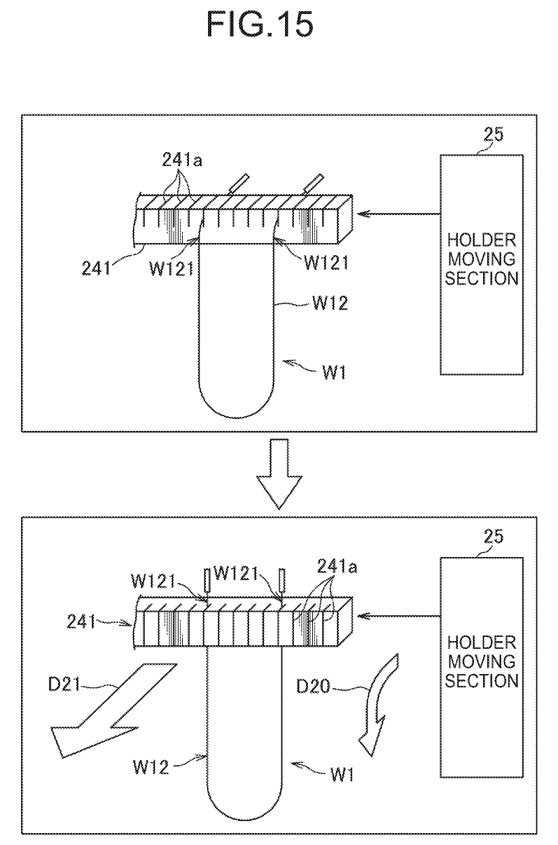

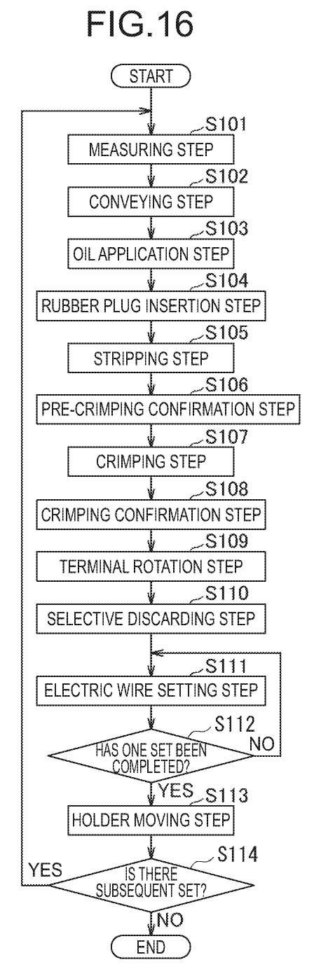

### BRIEF DESCRIPTION OF THE DRAWINGS

[FIG. 1] FIG. 1 is a perspective view illustrating a terminal crimping unit according to one embodiment.

[FIG. 2] FIG. 2 is a schematic block diagram illustrating a terminal crimping unit as illustrated in FIG. 1.

[FIG. 3] FIG. 3 is a perspective view illustrating a mechanical portion of a measuring section illustrated in FIGS. 1 and 2.

[FIG. 4] FIG. 4 is a diagram illustrating how a harness-use electric wire is pulled out in a U-shaped bent state in the measuring section illustrated in FIG. 3.

[FIG. 5] FIG. 5 is a schematic diagram illustrating a conveying section illustrated in FIG. 1 and FIG. 2.

[FIG. 6] FIG. 6 is a perspective view illustrating each mechanical portion of sections from a trimming section to a pre-crimping photography section in a first unit illustrated in FIG. 1 and FIG. 2.

[FIG. 7] FIG. 7 is a schematic diagram illustrating how a series of processes are performed by the sections from the trimming section to the pre-crimping photography section illustrated in FIG. 6.

[FIG. 8] FIG. 8 is a perspective view illustrating a second unit illustrated in FIG. 1 and FIG. 2.

[FIG. 9] FIG. 9 is a perspective view illustrating a mechanical portion of a crimping section in the second unit illustrated in FIG. 8.

[FIG. 10] FIG. 10 is a schematic diagram illustrating how a series of processes are performed by the crimping section illustrated in FIG. 9.

[FIG. 11] FIG. 11 is a perspective view of a third unit illustrated in FIG. 1 and FIG. 2, with some of the covers removed so as to show the sections from the crimping confirmation section to the selective discarding section.

[FIG. 12] FIG. 12 is a schematic diagram illustrating how a series of processes are performed by the crimping confirmation section and a terminal rotation section illustrated in FIG. 11.

[FIG. 13] FIG. 13 is a schematic diagram illustrating the processes performed by the selective discarding section illustrated in FIG. 11.

[FIG. 14] FIG. 14 is a perspective view illustrating an electric wire setting section illustrated in FIGS. 1 and 2.

[FIG. 15] FIG. 15 is a perspective view illustrating the processes performed by a holder moving section illustrated in FIG. 1 and FIG. 2.

[FIG. 16] FIG. 16 is a schematic flowchart illustrating a flow of processes of a terminal crimping method performed by the terminal crimping unit illustrated in FIG. 1 to FIG. 15.

### DETAILED DESCRIPTION OF THE EXEMPLARY EMBODIMENT

An embodiment of a terminal crimping unit and a terminal crimping method is described below.

FIG. 1 is a perspective view illustrating a terminal crimping unit according to one embodiment. FIG. 2 is a schematic block diagram illustrating a terminal crimping unit as illustrated in FIG. 1.

The terminal crimping unit 1 according to the present embodiment is, for example, a work unit for manufacturing a terminal-attached electric wire W1 constituting a wire harness that is installed and routed in a vehicle or the like. In the terminal crimping unit 1, a required length of a harness-use electric wire W12 is cut out from an electric wire reel 111 stored in the electric wire storage section 11, and connector terminals W11 are crimped to both ends of the electric wire to produce a terminal-attached electric wire W1. The terminal-attached electric wires W1 are manufactured in the number required for manufacturing one wire harness, and are set in a rod-shaped electric wire holder 241 so that both ends thereof are held in a U-shaped bent state. When all the terminal-attached electric wires W1 have been set, the electric wire holder 241 with the electric wires being set therein is taken out from the terminal crimping unit 1 by a worker Y1.

The terminal crimping unit 1 includes an electric wire storage section 11, a measuring section 12, a conveying section 13, a trimming section 14, an oil application section 15, a rubber plug insertion section 16, and a stripping section 17. Furthermore, the terminal crimping unit 1 includes a pre-crimping photography section 18, a crimping section 19, a crimping confirmation section 21, a terminal rotation section 22, a selective discarding section 23, an electric wire setting section 24, and a holder moving section 25. The trimming section 14, the oil application section 15, the rubber plug insertion section 16, the stripping section 17, and the pre-crimping photography section 18 are contained in a first unit 1a, and the crimping section 19 is contained in a second unit 1b. The crimping confirmation section 21, the terminal rotation section 22, and the selective discarding section 23 are contained in a third unit 1c. The conveying section 13 connects the measuring section 12 and the electric wire setting section 24, passing through the first unit 1a, the second unit 1b, and the third unit 1c. Each portion will be described below with reference to other drawings.

The electric wire storage section 11 is a storage shelf for electric wire reels 111, and stores a plurality of electric wire reels 111, including those of different thicknesses and the like. From the plurality of electric wire reels 111, those to be used for the wire harness to be manufactured are selected, and the electric wire is pulled out from each selected electric wire reel 111 and pulled into the measuring section 12 of the terminal crimping unit 1.

FIG. 3 is a perspective view illustrating a mechanical portion of a measuring section illustrated in FIGS. 1 and 2. FIG. 4 is a diagram illustrating how a harness-use electric wire is pulled out in a U-shaped bent state in the measuring section illustrated in FIG. 3.

The measuring section 12 is a section that cuts out a plurality of harness-use electric wires W12 in sequence by repeating a measuring process of pulling out and cutting an electric wire 111a by a required length from the electric wire reel 111. The measuring section 12 cuts out the harness-use electric wires W12 in a U-shaped bent state, and includes an electric wire pull-out mechanism 121 and a U-shaped bend turn mechanism 122. The electric wire pull-out mechanism 121 is a mechanical portion that pulls out the electric wire 111a from the electric wire reel 111 while measuring the pull-out length. The U-shaped bend turn mechanism 122 is a mechanical portion that bends the electric wire 111a into a U-shape by rotating a tip chuck 122a, which grips the pull-out end portion 111a-1 of the pulled-out electric wire 111a, by 180 degrees in a turn direction D11 using a turn drive mechanism 122b. While bending the electric wire 111a in this manner by the U-shaped bend turn mechanism 122, the electric wire pull-out mechanism 121 pulls out the electric wire 111a until the pull-out length reaches the required length. When the pull-out length reaches the required length, the cutting chuck 121a of the electric wire pull-out mechanism 121 cuts the electric wire 111a and grips the cut end portion, thereby cutting out the harness-use electric wire W12 in the U-shaped bent state. The cutting chuck 121a is located at a position 180 degrees away in the turn direction D11 from the rotated tip chuck 122a. The harness-use electric wire W12 cut out sequentially by the measuring section 12 is delivered to the conveying section 13 sequentially in the order of cutting while still in the U-shaped bent state.

FIG. 5 is a schematic diagram illustrating a conveying section illustrated in FIG. 1 and FIG. 2.

The conveying section 13 is a section which sequentially receives the harness-use electric wire W12 from the measuring section 12, grips the electric wire end portions W121 thereof, and conveys them along a predetermined conveying route R11. As described above, the measuring section 12 cuts out the harness-use electric wire W12 in the U-shaped bent state. The conveying section 13 receives the harness-use electric wire W12 in the U-shaped bent state, grips the electric wire end portions W121 at both ends thereof, and conveys it in the U-shaped bent state. The conveying section 13 is equipped with an electric wire transport chuck 131 and an electric wire conveying mechanism 132.

The electric wire transport chuck 131 is a mechanism that grips and removes the electric wire end portion W121 at both end portions of the harness-use electric wire W12 that are gripped by the tip chuck 122a and the cutting chuck 121a immediately after they are cut by the measuring section 12, and transports them to the electric wire conveying mechanism 132. The electric wire transport chuck 131 is equipped with a pair of chuck portions 131a that grip both end portions of the harness-use electric wire W12, and a chuck drive mechanism 131b that drives the pair of chuck portions 131a and reciprocates between the measuring section 12 and the electric wire conveying mechanism 132.

The electric wire conveying mechanism 132 is a portion that grips the end portions of the harness-use electric wire W12 sequentially transported by the electric wire transport chuck 131 and conveys them along the conveying route R11 to the electric wire setting section 24. The electric wire conveying mechanism 132 receives the harness-use electric wire W12 while it is in a U-shaped bent state from the electric wire transport chuck 131. The electric wire conveying mechanism 132 then grips the electric wire end portions W121 at both ends of the harness-use electric wire W12 in the U-shape so that they are aligned in a row along the conveying route R11, thereby conveying the harness-use electric wire W12 in the U-shaped bent state.

The conveying route R11 is a route for circulating in a rectangular loop with its longer side direction extending from the measuring section 12 to the electric wire setting section 24. The electric wire conveying mechanism 132 has a conveying rail 132a disposed along the upper side of the conveying route R11 of the rectangular loop with respect to the up-down direction D12 of the terminal crimping unit 1. The constituent elements from the measuring section 12 to the electric wire setting section 24 are arranged above this conveying rail 132a along the upper side of the conveying route R11.

The electric wire conveying mechanism 132 is equipped with a plurality of conveying chucks 133 that move in a circular manner along the conveying route R11. These conveying chucks 133 are arranged in a row along the conveying route R11 at regular intervals, and a pair of conveying chucks 133 move while gripping the electric wire end portions W121 at both end portions of one harness-use electric wire W12. When any given conveying chuck 133 moves to the electric wire setting section 24, the conveying chuck 133 releases the electric wire end portion W121, disengages from the conveying rail 132a, and returns empty under the conveying rail 132a to the vicinity of the measuring section 12, then returns to the conveying rail 132a. If there is still harness-use electric wire W12 to be conveyed, the conveying chuck 133 receives again the electric wire end portion W121 from electric wire transport chuck 131 upon returning and moves along the conveying route R11.

The harness-use electric wire W12 conveyed by the conveying section 13 undergoes a series of processes performed by the sections from the trimming section 14 to the pre-crimping photography section 18 while being conveyed inside the first unit 1a.

FIG. 6 is a perspective view illustrating each mechanical portion of the sections from the trimming section to the pre-crimping photography section inside the first unit illustrated in FIG. 1 and FIG. 2. FIG. 7 is a schematic diagram illustrating how a series of processes are performed by the sections from the trimming section to the pre-crimping photography section illustrated in FIG. 6.

The trimming section 14 is located, on the conveying route R11, upstream of the sections from the oil application section 15 to the pre-crimping photography section 18, and performs the following trimming process on the harness-use electric wire W12 that is gripped and conveyed by the conveying chucks 133 along the conveying route R11. The trimming process is a process in which the tips of the electric wire end portions W121, which are conveyed in a row along the conveying route R11, are trimmed so that they are aligned with a predetermined tip position P11. The trimming section 14 includes a cutting mechanism 141 that trims each tip, and a cutting drive mechanism 142 that drives the cutting mechanism 141. The cutting drive mechanism 142 moves a cutting blade 141a of the cutting mechanism 141 in a cutting direction D13 at a predetermined tip position P11, so that the electric wire end portion W121 is trimmed to the tip position P11. The electric wire end portion W121 that has undergone the trimming process is sent to the oil application section 15.

The oil application section 15 is located upstream of the rubber plug insertion section 16 on the conveying route R11, and performs the oil application process on the harness-use electric wire W12 to which a rubber plug has not yet been inserted.

Here, the electric wire storage section 11 stores a plurality of types of electric wire reels 111 which are different in the thickness and the like. For rubber plug-required electric wires that require the insertion of rubber plugs W13 among the harness-use electric wires W12, the rubber plug insertion section 16 can insert a plurality of types of rubber plugs W13 which are different in the hole diameters and the like into the electric wire end portions W121 of the harness-use electric wires W12. Depending on the combination of the electric wire reel 111 (i.e., the type of the harness-use electric wire W12 cut out from it) and the type of the rubber plug W13 to be inserted, friction between the two may be large, making it difficult to insert the rubber plug W13. In the oil application section 15, rubber plug-required electric wires that are difficult to be inserted with rubber plugs W13 are designated as targets for lubrication with lubrication oil.

For a specified lubrication-required electric wire, the oil application section 15 performs an oil application process for applying lubrication oil to the electric wire end portion W121 before the rubber plug insertion process. The oil application section 15 applies lubrication oil by clamping the electric wire end portion W121 with a pair of gripping pieces 151 impregnated with lubrication oil. The oil application section 15 includes the pair of gripping pieces 151 and an oil application drive mechanism 152 that drives one of the gripping pieces 151 in the clamping direction D14 for the electric wire end portion W121. The lubrication-required electric wire undergoes this oil application process, and the electric wire end portion W121 is sent to the rubber plug insertion section 16.

The rubber plug insertion section 16 is located upstream of the crimping section 19 on the conveying route R11, specifically upstream of the stripping section 17, to perform rubber plug insertion process. The rubber plug insertion process is performed when a harness-use electric wire W12 used for a waterproof connector or the like is designated as being inserted with the rubber plug W13, and the rubber plug insertion process is a process of inserting the rubber plug W13 around the electric wire end portion W121 of the specified rubber plug-required electric wire. Among the rubber plug-required electric wires, lubrication-required electric wires that are further specified to be coated with lubrication oil undergo the oil application process described above and then the rubber plug insertion process. The rubber plug insertion section 16 for performing the rubber plug insertion process includes a plurality of insertion mechanisms 161 and an insertion drive mechanism 162. The plurality of insertion mechanisms 161 is a plurality of mechanism portions that hold various types of rubber plugs W13 and insert them around the electric wire end portions W121. The insertion drive mechanism 162 is a mechanism portion that drives each insertion mechanism 161 in the up-and-down direction D12 to an insertion position for the electric wire end portion W121 to be inserted, and also drives it in an insertion direction D15 to insert the rubber plug W13 around the electric wire end portion W121. The electric wire end portions W121 of the rubber plug-required electric wires and the lubrication-required electric wires are sent to the stripping section 17 after the process in the rubber plug insertion section 16. The electric wire end portions W121 of the other harness-use electric wires W12 are sent to the stripping section 17 without the oil application process and the rubber plug insertion process being performed.

The stripping section 17 is located upstream of the crimping section 19 and downstream of the rubber plug insertion section 16 on the conveying route R11, and performs a stripping process on the conveyed harness-use electric wire W12 by removing a tip coating W121b of the electric wire end portion W121 to expose a core wire W121a. The stripping section 17 is equipped with a pair of stripping blades 171 that clamp and cut off the tip coating W121b to remove it, and a stripping drive mechanism 172 that drives the pair of stripping blades 171 in the stripping direction D16. After the process in the stripping section 17, the harness-use electric wire W12 undergoes a pre-crimping photography process in the pre-crimping photography section 18 at the same position.

The pre-crimping photography section 18 is located in the same position as the stripping section 17 on the conveying route R11. The pre-crimping photography section 18 performs a pre-crimping photography process on the harness-use electric wire W12 that has been gripped by the conveying chuck 133 and passed through the stripping section 17, prior to the crimping process in the crimping section 19. The pre-crimping photography process is a process for obtaining a pre-crimping image G11 by photographing the electric wire end portion W121 from which the tip coating W121b has been removed to expose the core wire W121a and around which, for the specified one, the rubber plug W13 has been inserted. The pre-crimping photography section 18 is equipped with a pre-crimping camera 181 for photography and a pre-crimping image display section 182 that displays the pre-crimping image G11. The pre-crimping image G11 photographed here is sent to the crimping confirmation section 21 as image data, and a determination section 213 in this crimping confirmation section 21, described below, determines whether the stripping criteria are satisfied. The harness-use electric wire W12 having the electric wire end portion W121 that has been photographed leaves the first unit 1a and is sent to the second unit 1b, where the harness-use electric wire W12 is conveyed through the inside of the second unit 1b and undergoes the crimping process in the crimping section 19.

FIG. 8 is a perspective view illustrating a second unit illustrated in FIG. 1 and FIG. 2. FIG. 9 is a perspective view illustrating a mechanical portion of a crimping section inside the second unit illustrated in FIG. 8. FIG. 10 is a schematic diagram illustrating how a series of processes are performed by the crimping section illustrated in FIG. 9.

The crimping section 19 is located downstream of the stripping section 17 on the conveying route R11, and performs a crimping process on the harness-use electric wire W12 conveyed through the stripping section 17. The crimping section 19 includes a terminal holding portion 191 that holds a plurality of types of connector terminals W11 of different sizes in a pre-clamping expanded state, and a plurality of crimping mechanisms 192 provided corresponding to the respective types of connector terminals W11. Furthermore, the crimping section 19 includes a servo motor 193 as a common drive source for the plurality of crimping mechanisms 192. The plurality of crimping mechanisms 192 are aligned in a row along the conveying route R11. In the crimping process in the crimping section 19, from among the plurality of crimping mechanisms 192, a crimping mechanism 192 at a position, corresponding to the type of the connector terminal W11 to be crimped, at which the electric wire end portion W12 has arrived, performs the crimping process. In this crimping process, the connector terminal W11 is crimped to the electric wire end portion W121 where the core wire W121a is exposed. At this time, the connector terminal W11 of the rubber plug-required electric wire, which has the rubber plug W13 inserted around the electric wire end portion W121, is crimped over the rubber plug. Each crimping mechanism 192 includes an anvil 192a, a crimper 192b, and a clutch 192c as a drive transmission mechanism. An anvil 192a is a portion on which the connector terminal W13 in the expanded state is placed with the electric wire end portion W121 placed on its upper surface. The crimper 192b is a portion that performs crimping by deforming connector terminal W13 by sandwiching the connector terminal W13 and the electric wire end portion W121 between the anvil 192a and the crimper 192b. The clutch 192c transmits the drive force from the servo motor 193 to the crimper 192b. The crimper 192b, which has received the drive force from the clutch 192c, descends toward the anvil 192a and performs crimping. After completing the process in the crimping section 19, the harness-use electric wire W12 leaves the second unit 1b and is sent to the third unit 1c, and while the harness-use electric wire W12 is conveyed through the inside of the third unit 1c, the harness-use electric wire W12 undergoes a series of processes by the sections from the crimping confirmation section 21 to the selective discarding section 23.

FIG. 11 is a perspective view of a third unit illustrated in FIG. 1 and FIG. 2, with some of the covers removed so as to show the sections from the crimping confirmation section to the selective discarding section. FIG. 12 is a schematic diagram illustrating how a series of processes are performed by the crimping confirmation section and the terminal rotation section illustrated in FIG. 11. FIG. 13 is a schematic diagram illustrating the processes performed by the selective discarding section illustrated in FIG. 11.

The crimping confirmation section 21 is located downstream of the crimping section 19 on the conveying route R11, and is a section for performing a crimping confirmation process on the harness-use electric wire W12 conveyed through the crimping section 19. In the crimping confirmation process, first, the electric wire end portion W121 where the connector terminal W11 has been crimped is photographed. Then, based on the photographed post-crimping image G12, it is determined whether the predetermined crimping criteria are satisfied. The crimping confirmation section 21 includes a post-crimping camera 211 for photography, a post-crimping image display section 212 for displaying a post-crimping image G12, and a determination section 213 for performing a determination process. When the electric wire end portion W121, which has been crimped and which is gripped and conveyed by the conveying chuck 133, reaches directly below the post-crimping camera 211, the post-crimping camera 211 photographs the image thereof. The photographed post-crimping image G12 is displayed on the post-crimping image display section 212 and is sent to the determination section 213 as image data. The determination section 213 determines whether the crimping criteria are satisfied based on the post-crimping image G12 sent from the post-crimping camera 211. The result of the determination regarding the crimping criteria, along with the result of the determination regarding the stripping criteria based on the pre-crimping image G11 from the pre-crimping photography section 18 described above, are sent to the selective discarding section 23.

The terminal rotation section 22 is a section located at any given position downstream of the crimping confirmation section 21 on the conveying route R11, specifically, between the crimping confirmation section 21 and the selective discarding section 23. This terminal rotation section 22 performs a terminal rotation process on a rotation-required electric wire among the harness-use electric wires W12 conveyed through the crimping confirmation section 21. The rotation-required electric wire is an electric wire that is used in a subsequent step, such as insertion into a cavity of a connector housing, in a rotated orientation in which the connector terminal W11 is rotated about the axis W11a of the connector terminal W11 from the orientation at the time of crimping in the crimping section 19. In the terminal rotation process, the rotation-required electric wire is specified, and the connector terminal W11 is rotated in a rotation direction D17 about the axis W11a. The terminal rotation section 22 includes a rotation chuck 221 and a rotation drive mechanism 222. When the electric wire end portion W121 of the rotation-required electric wire is gripped by the conveying chuck 133 and conveyed, the rotation chuck 221 grips a portion of the electric wire end portion W121 adjacent to the connector terminal W11. The rotation drive mechanism 222 rotates the rotation chuck 221 gripping the electric wire end portion W121 in the rotation direction D17 to perform the above terminal rotation process. In the present embodiment, the rotated orientation of the rotation-required electric wire is an inverted orientation in which the connector terminal W11 is inverted 180 degrees about the axis W11a from the orientation at the time of crimping. The rotation drive mechanism 222 inverts the connector terminal W11 by rotating the rotation chuck 221 gripping the electric wire end portion W121 180 degrees in the rotation direction D17.

The selective discarding section 23 is located downstream of the crimping confirmation section 21, specifically downstream of the terminal rotation section 22 on the conveying route R11, and is a section for performing the selective discarding process on the harness-use electric wire W12 that is conveyed through the crimping confirmation section 21 and the terminal rotation section 22. In the selective discarding process, a harness-use electric wire W12 that is determined to meet both the stripping criteria and the crimping criteria in the determination section 123 is handed over by the conveying section 13 as a qualified terminal-attached electric wire W1 to the electric wire setting section 24, where the harness-use electric wire W12 undergoes an electric wire setting process that is a subsequent step. Conversely, a harness-use electric wire W12 that is determined not to satisfy at least one of the stripping criteria and the crimping criteria is discarded as a terminal-attached electric wire W1 of an unqualified product. The selective discarding section 23 is equipped with a discarding mechanism 231 that removes and picks up, from the conveying chuck 133, the electric wire end portions W121 at both ends of the terminal-attached electric wire W1 of the unqualified product, and transports them to a discarding position 231a for discarding.

FIG. 14 is a perspective view illustrating an electric wire setting section illustrated in FIGS. 1 and 2.

The electric wire setting section 24 is located downstream of the selective discarding section 23 on the conveying route R11, i.e., at the end of the conveying route R11, and is a section for performing the electric wire setting process on the harness-use electric wire W12 that meets the crimping criteria and is conveyed along this conveying route R11. The harness-use electric wire W12 that is to undergo this electric wire setting process is the terminal-attached electric wire W1, a qualified product, which is conveyed in the U-shaped bent state with the connector terminals W11 crimped on the electric wire end portions W121 at both ends. In the electric wire setting process, the electric wire end portions W121 at both ends of the U-shaped terminal-attached electric wire W1 are removed from the conveying route R11 and transported to and held in the rod-shaped electric wire holder 241.

The electric wire setting section 24 has two pairs of setting mechanisms 242 that remove, from the conveying chuck 133 of the conveying section 13, the electric wire end portions W121 at both ends of the terminal-attached electric wire W1 and transport them to a holding position in the electric wire holder 241 so that the electric wire holder 241 holds them. The rod-shaped electric wire holder 241 has a number of slits 241a arranged in a row along a rod length direction D18 into which the harness-use electric wire W12 of the terminal-attached electric wire W1 can be inserted. The pair of setting mechanisms 242 holds the electric wire end portions W121 by inserting them into a pair of slits 241a that is specified for each terminal-attached electric wire W1. In this case, if the specified distance between the pair of slits 241a is such that the pair of setting mechanisms 242 can be inserted side by side, the electric wire end portions W121 at both ends of one terminal-attached electric wire W1 are set simultaneously. In the present embodiment, two pairs of setting mechanisms 242 are provided, so that such simultaneous setting of both ends can be performed for a maximum of two terminal-attached electric wires W1. Conversely, if the specified distance between the pair of slits 241a is too wide or too narrow, the setting of each electric wire end portion W121 is performed individually by the corresponding setting mechanism 242. The electric wire setting section 24 is equipped with a setting drive mechanism 243 that reciprocates these two setting mechanisms 242 between the conveying chuck 133 and the slit 241a of the electric wire holder 241 along the setting movement direction D19. This electric wire setting process by the electric wire setting section 24 continues until all of the terminal-attached electric wires W1 to be manufactured have been set in the electric wire holder 241. When the setting of all of the terminal-attached electric wires W1 has been completed, the holder moving section 25 processes the electric wires in the electric wire holders 241 that are holding the electric wires.

FIG. 15 is a perspective view illustrating the processes performed by a holder moving section illustrated in FIG. 1 and FIG. 2.

The holder moving section 25 is disposed in a position adjacent to the electric wire setting section 24. Then, the holder moving section 25 performs a holder moving process on the electric wire holder 241 that has held all of the harness-use electric wires W12, i.e., the terminal-attached electric wires W1, to be manufactured, which satisfy the crimping criteria and have undergone the electric wire setting process in the electric wire setting section 24. The holder moving process is a process of moving the electric wire holder 241 holding the electric wires to a delivery position 251 illustrated in FIG. 1. Here, during the electric wire setting process in the electric wire setting section 24, the electric wire holder 241 is oriented with the slits 241a facing upward so that the setting mechanism 242 of the electric wire setting section 24 can access it from above and insert the electric wire end portions W121 into the slits 241a. Therefore, after the electric wire setting, the terminal-attached electric wires W1 are held in a state in which the electric wire end portions W121 are bent 90° and hang down near the slits 241a. The holder moving section 25 tilts the electric wire holder 241 to a side by 90° in a tilting direction D20 so that the bends at the electric wire end portions W121 of each terminal-attached electric wire W1 are eliminated and the wire hangs down straight to form a U-shape in the holder moving process. In the holder moving process, the electric wire holder 241 is then slid to the delivery position 251 in a delivery direction D21 that intersects with the electric wire holder 241, and is temporarily stored at the delivery position 251.

This holder moving process is performed every time the electric wire setting process is performed in the electric wire setting section 24, and the electric wire holders 241 each holding a plurality of electric wires are stored in parallel in the delivery position 251. The electric wire holders 241 are taken out of the delivery position 251 by a worker at an appropriate timing and transported to a unit or the like where a subsequent step such as insertion into a cavity of a connector housing is performed.

Next, a terminal crimping method executed in the terminal crimping unit 1 according to the present embodiment will be explained below with reference to FIGS. 1 to 15 and FIG. 16 below, although some of the explanation overlaps with those given so far.

FIG. 16 is a schematic flowchart illustrating a flow of processes of a terminal crimping method performed by the terminal crimping unit illustrated in FIG. 1 to FIG. 15.

The process of the terminal crimping method illustrated in the flowchart of FIG. 16 starts when a worker inputs the part number of the product to be manufactured using an input device such as a personal computer (PC) and performs a predetermined start operation on the input device. When the process starts, the measuring section 12 repeats a measurement process including pulling out and cutting the electric wire 111a to the required length, thereby executing a measuring step S101 in which a plurality of harness-use electric wires W12 are cut out in sequence. Next, a conveying step S102 is performed in which the harness-use electric wire W12 is gripped by the electric wire end portions W121 at both ends and handed over to the conveying section 13 conveying the harness-use electric wire W12 along the predetermined conveying route R11, and the harness-use electric wire W12 is conveyed to the conveying section 13. A subsequent oil application step S103 and a rubber plug insertion step S104 are performed for those harness-use electric wires W12 conveyed along the conveying route R11 that are specified as rubber plug-required electric wires. In addition, the oil application step S103 is performed for those rubber plug-required electric wires that are further specified as lubrication-required electric wires.

In the oil application step S103, lubrication oil is applied to the electric wire end portions W121 of the specified lubrication-required electric wire before the rubber plug insertion step S104. In the rubber plug insertion step S104, the rubber plugs W13 are inserted around the electric wire end portions W121 of the specified rubber plug-required electric wire.

Next, a stripping step S105 is performed in which the tip coatings W121b of the electric wire end portions W121 of the harness-use electric wire W12 conveyed along the conveying route R11 are removed to expose the core wires W121a. The electric wire end portions W121 of the harness-use electric wire W121 that has undergone the stripping step S105 to remove the tip coatings W121b is photographed before a crimping step S107 described below to obtain a pre-crimping image G11, and a pre-crimping confirmation step S106 is performed to determine whether the pre-determined stripping criteria are satisfied. In the crimping step S107 following the pre-crimping confirmation step S106, the connector terminals W11 are crimped to the electric wire end portions W121, where the core wires W121a of the harness-use electric wire W12 are exposed, of the harness-use electric wire W12 that has been conveyed through the stripping step S105 and the pre-crimping confirmation step S106.

Next, a crimping confirmation step S108 is performed on the electric wire end portions W121 where the connector terminals W11 of the harness-use electric wire W12 conveyed through the crimping step S107 have been crimped. In the crimping confirmation step S108, the post-crimping image G12 of the electric wire end portions W121 which have been crimped is photographed to determine whether the predetermined crimping criteria are satisfied.

The terminal rotation step S109 following this crimping confirmation step S108 is performed on those harness-use electric wires W12 conveyed through the crimping step S107 that are specified as the rotation-required electric wires. The rotation-required electric wires are electric wires that are to be used in a subsequent step in a rotated orientation in which the connector terminals W11 are rotated about the axis W11a from the orientation at the time of crimping, and in the terminal rotation step S109, the connector terminals W11 of this rotation-required electric wire are rotated about the axis W11a. As described above, in the present embodiment, the connector terminals W11 are rotated 180° about the axis W11a from the orientation at the time of crimping.

In the next selective discarding step S110, the harness-use electric wire W12 that is determined to satisfy the stripping criteria in the pre-crimping confirmation step S106 and also to satisfy the crimping criteria in the crimping confirmation step S108 is delivered to the subsequent step as a terminal-attached electric wire W1 of a qualified product. Conversely, the harness-use electric wire W12 that does not satisfy at least one of the stripping criteria and the crimping criteria is discarded as an unqualified terminal-attached electric wire W1. Then, for the terminal-attached electric wire W1 that is determined to be a qualified product in the selective discarding step S110, an electric wire setting step S111 is performed in which the electric wire end portions W121 with the connector terminals W11 crimped thereto are removed from the conveying route R11 and transported to and held in the rod-shaped electric wire holder 241.

After the electric wire setting step S111, a primary determination step S112 is executed to determine whether setting of all of the terminal-attached electric wires W1 of one set to be manufactured in the electric wire holder 241 has been completed. If the setting for one set has not been completed (NO determination), the primary determination step S112 is repeated each time a terminal-attached electric wire W1 is subsequently set in the electric wire setting step S111. Then, if the setting for one set has been completed (YES determination), a holder moving step S113 is executed to move the electric wire holder 241 holding the electric wires to the delivery position 251.

After the holder moving step S113, a secondary determination step S114 is executed to determine whether to continue setting the terminal-attached electric wire W1 to the new electric wire holder 241. If the setting to the electric wire holder 241 is to be continued (YES determination), the process returns to measuring step S101 and the subsequent processes are repeated. Conversely, if the setting to the electric wire holder 241 is not to be performed (NO determination), the process of this terminal crimping method is terminated.

The terminal crimping unit 1 and the terminal crimping method according to the embodiment described above can provide the following effects. That is, according to the present embodiment, the harness-use electric wire W12 is cut out in sequence and conveyed along the predetermined conveying route R11. Then, along the conveying route R11, the series of processes including stripping of the electric wire end portions W121, crimping of the connector terminals W11, crimping confirmation, and selective discarding of the unqualified products are smoothly performed. In this way, according to the present embodiment, the connector terminals W11 can be crimped on the harness-use electric wire W12 while reducing various burdens on the worker Y1.

Here, in the present embodiment, the measuring section 12 cuts out the harness-use electric wire W12 in the U-shaped bent state, and the conveying section 13 receives the harness-use electric wire W12 from the measuring section 12 while the harness-use electric wire W12 is in the U-shaped bent state. The conveying section 13 conveys the harness-use electric wire W12 while the harness-use electric wire W12 is in the U-shaped bent state by holding the electric wire end portions W121 at both ends of the harness-use electric wire W12 so that the electric wire end portions W121 are aligned in a row along the conveying route R11. According to this configuration, the terminal crimping of the electric wire end portions W121 at both ends can be performed sequentially without changing the direction of the harness-use electric wire W12, so that the burden on the worker Y1 can be further reduced.

Furthermore, in the present embodiment, the trimming section 14, which trims and aligns the tips of electric wire end portions W121, is provided upstream of the stripping section 17 on the conveying route R11. According to this configuration, the tips of electric wire end portions W121 of the harness-use electric wire W12 conveyed along the conveying route R11 are trimmed and align, improving the accuracy of terminal crimping.

Furthermore, in the present embodiment, the crimping confirmation section 21 has the post-crimping image display section 212 that displays the post-crimping image G12. This configuration is preferable because this configuration allows the worker Y1 to visually grasp the post-crimping image G12 via the post-crimping image display section 212.

Furthermore, in the present embodiment, the pre-crimping photography section 18 is provided at the same position as the stripping section 17 on the conveying route R11, which obtains the pre-crimping image G11 by photographing the electric wire end portions W121 from which the tip coatings W121b have been removed before the crimping process. Then, based on this pre-crimping image G11, it is determined whether the stripping criteria are satisfied. According to this configuration, the crimping confirmation process is performed based on the stripping state of the electric wire end portions W121 illustrated in the pre-crimping image G11, so that the confirmation accuracy can be improved. In the present embodiment, the determination regarding the stripping criteria is performed in the determination section 213 of the crimping confirmation section 21, which receives the pre-crimping image G11 from the pre-crimping photography section 18. However, the section for performing determination regarding the stripping criteria is not limited thereto, and a dedicated determination section may be provided separately from the determination section 213 of the crimping confirmation section 21 to perform determination regarding the stripping criteria.

Furthermore, in the present embodiment, the pre-crimping photography section 18 has the pre-crimping image display section 182 that displays the pre-crimping image G11. This configuration is preferable because this configuration allows the worker Y1 to visually grasp the pre-crimping image G11 via the pre-crimping image display section 182.

Furthermore, in the present embodiment, the rubber plug insertion section 16 is provided upstream of the crimping section 19 on the conveying route R11 to insert the rubber plugs W13 around the electric wire end portions W121 of the specified rubber plug-required electric wire. For the rubber plug-required electric wires, the crimping section 19 performs a process of crimping the connector terminals W11 over the rubber plugs. According to this configuration, the rubber plug insertion process for the rubber plug-required electric wires and the subsequent crimping process over the rubber plugs are incorporated into the series of processes after measuring, so that the burden on the worker Y1 can be further reduced.

Furthermore, in the present embodiment, the oil application section 15 is provided upstream of the rubber plug insertion section 16 on the conveying route R11 to apply, for the specified lubrication-required electric wires, lubrication oil to the electric wire end portions W121 prior to the rubber plug insertion process. According to this configuration, even when it is difficult to insert the rubber plugs W13 due to the thickness of the harness-use electric wire W12 or other factors, the oil application process in the oil application section 15 allows smooth rubber plug insertion process.

Furthermore, in the present embodiment, the electric wire setting section 24 is provided downstream of the selective discarding section 23 on the conveying route R11 to remove the electric wire end portions W121 of the harness-use electric wire W12 that satisfies the crimping criteria from the conveying route R11 and transport them to the electric wire holder 241 so that the electric wire holder 241 holds them. According to this configuration, the harness-use electric wires W12 having terminals attached thereto are sequentially set in the electric wire holder 241. The worker Y1 only needs to transport the electric wire holder 241 to the next work location, which further reduces the burden on the worker Y1 compared to the case where the worker Y1 removes, one by one, the harness-use electric wires W12 having terminals attached thereto from the conveying route R11 and transports them individually.

Furthermore, in the present embodiment, the electric wire setting section 24 simultaneously or sequentially removes the electric wire end portions W121 at both ends of the harness-use electric wire W12 in the U-shaped bent state from the conveying route R11 and transports them to the electric wire holder 241 so that the electric wire holder 241 holds them. In this way, the electric wire setting section 24 holds the harness-use electric wire W12 in the U-shaped bent state in the electric wire holder 241. According to this configuration, the electric wire end portions W121 at both ends of the harness-use electric wire W12 are set in the electric wire holder 241, so that it is possible to improve the ease of operations in the subsequent step of removing the harness-use electric wire W12 from the electric wire holder 241 and handling each electric wire end portion W121.

Furthermore, in the present embodiment, the holder moving section 25 is provided to move the electric wire holder 241 that holds the electric wires to the predetermined delivery position 251. According to this configuration, it is possible to improve the ease of operations of the worker Y1 in removing the electric wire holder 241 for transport to the subsequent step.

Furthermore, in the present embodiment, the terminal rotation section 22 that rotates the connector terminals W11 of the specified rotation-required electric wire around axis W11a is provided downstream of the crimping confirmation section 21 on the conveying route R11. According to this configuration, the terminal rotation process can be performed according to the handling situation of the electric wire end portions W121 in the subsequent step, improving the ease of operations in the subsequent step.

The above-described embodiment merely shows a representative form of the terminal crimping unit and the terminal crimping method. The terminal crimping unit and the terminal crimping method are not limited thereto, and can be embodied by being modified in various ways.

For example, in the above-described embodiment, the terminal crimping unit 1 and the terminal crimping method for manufacturing the terminal-attached electric wire W1 constituting the wire harness installed and routed in a vehicle or the like are shown as an example of the terminal crimping unit and the terminal crimping method. However, the terminal crimping unit and the terminal crimping method are not limited thereto, and the application to which they are applied is not particularly limited.

Furthermore, in the above-described embodiment, the terminal crimping unit 1, of which the specific shape and arrangement of each constituent element are illustrated in FIG. 1 and FIG. 2, and the terminal crimping method using the terminal crimping unit 1 are shown as an example of the terminal crimping unit and the terminal crimping method. However, the terminal crimping unit and the terminal crimping method are not limited thereto, and the specific shape and arrangement of the constituent elements of the terminal crimping unit are not particularly limited.

Furthermore, in the above-described embodiment, the terminal crimping unit 1 and the terminal crimping method in which the electric wire holder 241 holding the electric wires is taken out by the worker Y1 and then transported to a unit that performs the process of the subsequent step are shown as an example of the terminal crimping unit and the terminal crimping method. In the present embodiment, the terminal-attached electric wire W1 of the qualified product is delivered to the electric wire setting section 24 and set in the rod-shaped electric wire holder 241. However, the terminal crimping unit and the terminal crimping method are not limited thereto. The terminal crimping unit and the terminal crimping method may be a unit or a method that does not involve delivery to the electric wire setting section 24, setting in the electric wire holder 241, or transport of the electric wire holder 241 by the worker Y1. In such a unit and a method, the terminal-attached electric wires are delivered directly to a unit that performs a subsequent step of the process, such as a terminal insertion unit, and the terminal insertion unit performs a process such as terminal insertion.

Furthermore, in the above-described embodiment, the terminal rotation section 22 and the terminal rotation step S109 in which the connector terminals W11 are inverted from the orientation at the time of crimping to an orientation rotated 180 degrees about the axis W11a are shown as an example of the terminal rotation section and the terminal rotation step. However, the terminal rotation section and the terminal rotation step are not limited thereto, and the connector terminal may be rotated at any rotation angle about the axis from the orientation at the time of crimping.

### LIST OF REFERENCE SIGNS

1 terminal crimping unit

1a first unit

1b second unit

1c third unit

11 electric wire storage section

12 measuring section

13 conveying section

14 trimming section

15 oil application section

16 rubber plug insertion section

17 stripping section

18 pre-crimping photography section

19 crimping section

21 crimping confirmation section

22 terminal rotation section

23 selective discarding section

24 electric wire setting section

25 holder moving section

111 electric wire reel

111a electric wire

111a-1 pull-out end portion

121 electric wire pull-out mechanism

121a cutting chuck

122 U-shaped bend turn mechanism

122a tip chuck

122b turn drive mechanism

131 electric wire transport chuck

131a chuck portion

131b chuck drive mechanism

132 electric wire conveying mechanism

132a conveying rail

133 conveying chuck

141 cutting mechanism

141a cutting blade

142 cutting drive mechanism

151 gripping piece

152 oil application drive mechanism

161 insertion mechanism

162 insertion drive mechanism

171 stripping blade

172 stripping drive mechanism

181 pre-crimping camera

182 pre-crimping image display section

191 terminal holding portion

192 crimping mechanism

192a anvil

192b crimper

192c clutch

193 servo motor

211 post-crimping camera

212 post-crimping image display section

213 determination section

221 rotation chuck

222 rotation drive mechanism

231 discarding mechanism

231a discarding position

241 electric wire holder

241a slit

242 setting mechanism

243 setting drive mechanism

251 delivery position

D11 turn direction

D12 up-and-down direction

D13 cutting direction

D14 clamping direction

D15 insertion direction

D16 stripping direction

D17 rotation direction

D18 rod length direction

D19 setting movement direction

D20 tilting direction

D21 delivery direction

G11 pre-crimping image

G12 post-crimping image

P11 tip position

R11 conveying route

S101 measuring step

S102 conveying step

S103 oil application step

S104 rubber plug insertion step

S105 stripping step

S106 pre-crimping confirmation step

S107 crimping step

S108 crimping confirmation step

S109 terminal determination step

S110 selective discarding step

S111 electric wire setting step

S112 primary determination step

S113 holder moving step

S114 secondary determination step

W1 terminal-attached electric wire

W11 connector terminal

W11a axis

W12 harness-use electric wire

W13 rubber plug

W121 electric wire end portion

W121a core wire

W121b tip coating

Y1 worker

What is claimed is:

1. A terminal crimping unit comprising:
a measuring section configured to cut out in sequence a plurality of harness-use electric wires by repeating a measuring process including pulling out and cutting a required length of an electric wire;
a conveying section configured to receive in sequence the harness-use electric wires from the measuring section, grab and convey at least one of electric wire end portions along a predetermined conveying route;
a stripping section configured to perform, on the harness-use electric wires conveyed along the conveying route, a stripping process for removing tip coatings of the electric wire end portions to expose core wires;
a crimping section located downstream of the stripping section on the conveying route, and configured to perform, on the harness-use electric wires conveyed through the stripping section, a crimping process for crimping connector terminals to the electric wire end portions of which core wires are exposed;
a crimping confirmation section located downstream of the crimping section on the conveying route, and configured to perform, on the harness-use electric wires conveyed through the crimping section, a crimping confirmation process of photographing the electric wire end portions to which the connector terminals have been crimped, and determining whether predetermined crimping criteria are satisfied based on a photographed post-crimping image;
a selective discarding section located downstream of the crimping confirmation section on the conveying route, and configured to perform, on the harness-use electric wires conveyed through the crimping confirmation section, a selective discarding process of discarding the harness-use electric wires that do not satisfy the crimping criteria;
an electric wire setting section located downstream of the selective discarding section on the conveying route, and configured to perform, on the harness-use electric wires conveyed along the conveying route that satisfy the crimping criteria, an electric wire setting process of, by using a setting mechanism, removing, from the conveying route, the electric wire end portions to which the connector terminals have been crimped to transport the electric wire end portions to a predetermined electric wire holder so that the predetermined electric wire holder holds the electric wire end portions; and
a holder moving section disposed in a position adjacent to the electric wire setting section, and configured to perform a holder moving process of moving, to a delivery position, the electric wire holder that has held the harness-use electric wires and that has undergone the electric wire setting process,
wherein the electric wire holder is a rod-shaped member, and has a plurality of slits arranged in a row along a rod length direction into which the harness-use electric wires can be inserted,
the electric wire holder is arranged in an upward orientation in which the plurality of slits face upward with respect to a gravity direction during the electric wire setting process, and
the electric wire setting section causes the setting mechanism to access, from above in the gravity direction, the electric wire holder in the upward orientation to cause the electric wire holder to hold the harness-use electric wires, and
the holder moving section tilts the electric wire holder in the upward orientation to a sideway orientation in which the plurality of slits face a horizontal direction, and then, slides the electric wire holder to the delivery position.

2. The terminal crimping unit according to claim 1, wherein the measuring section cuts out the harness-use electric wires in a U-shaped bent state, and
the conveying section receives, from the measuring section, the harness-use electric wires kept in the U-shaped bent state, and grabs the electric wire end portions at both ends of the harness-use electric wires with the electric wire end portions being aligned in a row along the conveying route to convey the harness-use electric wires kept in the U-shaped bent state.

3. The terminal crimping unit according to claim 1, wherein the measuring section can cut out a plurality of types of harness-use electric wires.

4. The terminal crimping unit according to claim 1, further comprising:
a trimming section located upstream of the stripping section on the conveying route, and configured to perform a trimming process of trimming the harness-use electric wires conveyed along the conveying route so that tips of the electric wire end portions are aligned with a predetermined tip position.

5. The terminal crimping unit according to claim 1, wherein the crimping confirmation section includes a post-crimping image display section configured to display the post-crimping image.

6. The terminal crimping unit according to claim 1, comprising:
a pre-crimping photography section located at a same position as the stripping section on the conveying route, and configured to perform, on the harness-use electric wires passed through the stripping section, a pre-crimping photography process to photograph the electric wire end portions from which the tip coatings have been removed to obtain pre-crimping image before the crimping process; and
a determination section configured to determine whether predetermined stripping criteria are satisfied based on the pre-crimping image.

7. The terminal crimping unit according to claim 6, wherein the pre-crimping photography section includes a pre-crimping image display section configured to display the pre-crimping image.

8. The terminal crimping unit according to claim 1, further comprising:
a rubber plug insertion section located upstream of the crimping section on the conveying route, and configured to perform, on rubber plug-required electric wires specified as insertion target of rubber plugs from among the harness-use electric wires, a rubber plug insertion process of inserting the rubber plugs around the electric wire end portions,
wherein the crimping section performs, on the rubber plug-required electric wires, a process of crimping the connector terminals to the electric wire end portions over the rubber plugs as the crimping process.

9. The terminal crimping unit according to claim 8, wherein the rubber plug insertion section can insert a plurality of types of rubber plugs,
wherein the terminal crimping unit further comprises:
an oil application section located upstream of the rubber plug insertion section on the conveying route, and configured to perform, on lubrication-required electric wires specified as lubrication target to be lubricated with lubrication oil from among the rubber plug-required electric wires, an oil application process of applying the lubrication oil to the electric wire end portions before the rubber plug insertion process.

10. The terminal crimping unit according to claim 1, further comprising:
a terminal rotation section located at any given position downstream of the crimping confirmation section on the conveying route, and configured to perform a terminal rotation process of rotating the connector terminals about an axis of the connector terminals, on rotation-required electric wires specified, from among the harness-use electric wires conveyed through the crimping confirmation section, as electric wires that are used in a subsequent step in a rotated orientation in which the connector terminals are rotated about the axis from an orientation at a time of crimping in the crimping section.

11. A terminal crimping method comprising:
a measuring step of cutting out in sequence a plurality of harness-use electric wires by repeating a measuring process including pulling out and cutting a required length of an electric wire;
a conveying step of handing over the harness-use electric wires to a conveying section that grabs and conveys at least one of electric wire end portions along a predetermined conveying route, and causing the conveying section to convey the harness-use electric wires;
a stripping step of removing tip coatings of the electric wire end portions of the harness-use electric wires conveyed along the conveying route to expose core wires;
a crimping step of crimping connector terminals to the electric wire end portions, of which core wires are exposed, of the harness-use electric wires conveyed through the stripping step;
a crimping confirmation step of photographing the electric wire end portions, to which the connector terminals have been crimped, of the harness-use electric wires conveyed through the crimping step, and determining whether predetermined crimping criteria are satisfied based on a photographed post-crimping image;
a selective discarding step of discarding the harness-use electric wires of the harness-use electric wires conveyed through the crimping confirmation step that do not satisfy the crimping criteria;
an electric wire setting step of, by using a setting mechanism, removing, from the conveying route, the electric wire end portions, to which the connector terminals have been crimped, of the harness-use electric wires conveyed along the conveying route that satisfy the crimping criteria and transporting the electric wire end portions to a predetermined electric wire holder so that the predetermined electric wire holder holds the electric wire end portions; and
a holder moving step of moving, to a delivery position, the electric wire holder that has held the harness-use electric wires and that has undergone the electric wire setting step,
wherein the electric wire holder is a rod-shaped member, and has a plurality of slits arranged in a row along a rod length direction into which the harness-use electric wires can be inserted,
the electric wire holder is arranged in an upward orientation in which the plurality of slits face upward with respect to a gravity direction during the electric wire setting step, and
in the electric wire setting step, the setting mechanism is caused to access, from above in the gravity direction, the electric wire holder in the upward orientation to cause the electric wire holder to hold the harness-use electric wires, and
in the holder moving step, the electric wire holder in the upward orientation is tilted to a sideway orientation in which the plurality of slits face a horizontal direction, and then, the electric wire holder is slid to the delivery position.
